(19) United States
(12) Patent Application Publication
(10) Pub. No.: US 2023/0409994 A1
(43) Pub. Date: Dec. 21, 2023

(54) SPARE CAPACITY CALCULATION DEVICE, SPARE CAPACITY RESPONSE SYSTEM, METHOD, AND PROGRAM

(71) Applicant: NEC Corporation, Minato-ku, Tokyo (JP)

(72) Inventors: Kazuma Shimizu, Tokyo (JP); Satoshi Morinaga, Tokyo (JP); Shinji Nakadai, Tokyo (JP)

(73) Assignee: NEC Corporation, Minato-ku, Tokyo (JP)

(21) Appl. No.: 18/038,295

(22) PCT Filed: Nov. 27, 2020
(86) PCT No.: PCT/JP2020/044255

§ 371 Date: May 23, 2023

(51) Int. Cl. G06Q 10/0631

(52) U.S. Cl. CPC G06Q 10/0631

(57) ABSTRACT

The calculation means 82 calculates an accumulated material number by accumulating the number of materials in time series from a predetermined point in the past, and calculates the available number of materials by subtracting a cumulative production capacity accumulated up to an immediately preceding unit period among cumulative production capacities, each of which is a value obtained by accumulating a production capacity in each unit period in time series from the accumulated material number. Then, the calculation means 82 determines the smaller one of the number of products that can be produced, which is calculated based on the process capability, and the number of products that can be produced, which is calculated based on the available number of materials, as the production capacity, and accumulates the production capacities in time series from a predetermined point in the past to calculate the cumulative production capacity for each unit period.

### TECHNICAL FIELD

This invention relates to a spare capacity calculation device, a spare capacity calculation method and a spare capacity calculation program for calculating spare capacity, and a spare capacity response system and a spare capacity response method for responding about calculated spare capacity.

### BACKGROUND ART

In the manufacturing industry, manufacturers sometimes make a production plan based on demand information and order information, calculate the amount of parts required for manufacturing and work processes based on the plan, and make arrangements with suppliers and other parties. This method is called MRP (Manufacturing Resource Planning), and it enables a quick response to orders and understanding of in-house resources.

However, in order to implement this method without delay, manufacturers usually request suppliers to keep a certain quantity of parts in advance by informing the suppliers of expected requirements. In contrast, the supplier draws up a production plan for the parts to be provided based on its own productive capacity, responsive to the request from the manufacturer.

Patent Literature 1 describes a method for a production control of production of orders with specified delivery dates. In the method described in Patent Literature 1, a cumulative productive capacity is calculated by adding and accumulating the productive capacities in daily order.

### CITATION LIST

### Patent Literature

PTL 1: Japanese Patent Application Laid-Open No. 2002-244720

### SUMMARY OF INVENTION

### Technical Problem

MRP has an advantage of reducing the number of useless inventory for the manufacturer. On the other hand, the supplier must reserve materials to produce a percentage of surplus, taking into account the variation between the number of parts actually ordered by the manufacture and the number of parts requested in advance. This handling of the variation is beyond the scope of MRP and is a burden for the supplier.

To reduce this burden on the supplier, a possible method is for the manufacturer to request the supplier to place an order for a variable amount based on a spare capacity (spare productive capacity) of the supplier. However, in many cases, it is difficult for the manufacturer to directly calculate the spare capacity of the supplier. Therefore, it is necessary for the supplier to be able to calculate the spare capacity and respond to the manufacturer.

However, although the method described in Patent Document 1 takes into account a production schedule, it does not take into account materials required to produce each unit needed to assemble a house. Therefore, if materials required for production are insufficient, the appropriate spare capacity cannot be calculated.

Therefore, it is an object of the present invention to provide a spare capacity calculation device, a spare capacity calculation method and a spare capacity calculation program that can calculate a spare capacity taking into consideration processes and materials required for production of a product, and a spare capacity response system and a spare capacity response method that respond about calculated spare capacity.

### Solution to Problem

The spare capacity calculation device according to the present invention includes input means for accepting an input of a process capability to be made available for each unit period for each production process of a target product, and an input of the number of materials to be made available for each unit period, and calculation means for calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number, wherein the calculation means determines the smaller one of the number of products that can be produced, which is calculated based on the process capability, and the number of products that can be produced, which is calculated based on the available number of materials, as the production capacity, and accumulates the production capacities in time series from a predetermined point in the past to calculate the cumulative production capacity for each unit period.

The spare capacity response system according to the present invention includes a terminal which sends an inquiry about a production capacity to a spare capacity calculation device which calculates the spare capacity of a target product and responds, wherein the spare capacity calculation device includes, input means for accepting an input of a process capability to be made available for each unit period for each production process of the target product, and an input of the number of materials to be made available for each unit period, and calculation means for calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number, and wherein the calculation means determines the smaller one of the number of products that can be produced, which is calculated based on the process capability, and the number of products that can be produced, which is calculated based on the available number of materials, as the production capacity, and accumulates the production capacities in time series from a predetermined point in the past to calculate the cumulative production capacity which is unit period.

The spare capacity calculation method according to the present invention includes accepting an input of a process capability to be made available for each unit period for each production process of a target product, and an input of the number of materials to be made available for each unit period, calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number, and determining the smaller one of the number of products that can be produced, which is calculated based on the process capability, and the number of products that can be produced, which is calculated based on the available number of materials, as the production capacity, and accumulating the production capacities in time series from a predetermined point in the past to calculate the cumulative production capacity for each unit period.

In the spare capacity response method according to the present invention, a terminal sends an inquiry about a production capacity for a target product to a spare capacity calculation device which calculates the spare capacity and responds, and the spare capacity calculation device accepts an input of a process capability to be made available for each unit period for each production process of a target product, and an input of the number of materials to be made available for each unit period, calculates an accumulated material number by accumulating the number of materials in time series from a predetermined point in the past, and calculates the available number of materials by subtracting a cumulative production capacity accumulated up to an immediately preceding unit period among cumulative production capacities, each of which is a value obtained by accumulating the production capacity in each unit period in time series from the accumulated material number, and determines the smaller one of the number of products that can be produced, which is calculated based on the process capability, and the number of products that can be produced, which is calculated based on the available number of materials, as the production capacity, and accumulates the production capacities in time series from a predetermined point in the past to calculate the cumulative production capacity for each unit period.

The spare capacity calculation program according to the present invention causes a computer to execute an input process of accepting an input of a process capability to be made available for each unit period for each production process of a target product, and an input of the number of materials to be made available for each unit period, and a calculating process of calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number, wherein in the calculating process, the spare capacity calculation program causes the computer to execute determining the smaller one of the number of products that can be produced, which is calculated based on the process capability, and the number of products that can be produced, which is calculated based on the available number of materials, as the production capacity, and accumulating the production capacities in time series from a predetermined point in the past to calculate the cumulative production capacity for each unit period.

### Advantageous Effects of Invention

According to the present invention, a spare capacity can be calculated taking into consideration processes and materials required for production of a product.

### BRIEF DESCRIPTION OF DRAWINGS

FIG. 1 It depicts a block diagram showing a configuration example of an exemplary embodiment of a spare capacity response system according to the present invention.

FIG. 2A It depicts an explanatory diagram showing an example of a bill of process.

FIG. 2B It depicts an explanatory diagram showing an example of a bill of materials.

FIG. 3 It depicts an explanatory diagram showing an example of the process of calculating a cumulative production capacity.

FIG. 4 It depicts an explanatory diagram showing another example of the process of calculating a cumulative production capacity.

FIG. 5 It depicts an explanatory diagram showing a result of the process illustrated in FIG. 4.

FIG. 6 It depicts an explanatory diagram showing an example of a bill of process and bill of materials.

FIG. 7 It depicts an explanatory diagram showing a first example of the operation of the calculation unit.

FIG. 8 It depicts an explanatory diagram showing a second example of the operation of the calculation unit.

FIG. 9 It depicts an explanatory diagram showing a third example of the operation of the calculation unit.

FIG. 10 It depicts a flowchart showing an example of the operation of the spare capacity response system.

FIG. 11 It depicts a block diagram showing a modification of the spare capacity response system.

FIG. 12 It depicts a flowchart showing an example of the operation of a modification of the spare capacity response system.

FIG. 13 It depicts a block diagram showing an overview of the spare capacity calculation device according to the present invention.

FIG. 14 It depicts a block diagram showing an overview of the spare capacity response system according to the present invention.

FIG. 15 It depicts a summarized block diagram showing a configuration of a computer for at least one exemplary embodiment.

### DESCRIPTION OF EMBODIMENTS

As mentioned above, MRP is known as a planned production method in the manufacturing industry, which calculates a required productive capacity. After drawing up a production plan based on a demand forecast and other factors, MRP calculates resources (including personnel and parts) needed to make a product. Then, based on the demand forecast, etc., MRP communicates a required quantity as a so-called unofficial notice to suppliers.

In contrast, in the present invention, a spare capacity of the supplier is calculated and a surplus that can be supplied (hereinafter sometimes referred to as a production capacity) is disclosed. Specifically, in the present invention, the number of products (i.e., spare capacity) that can be made from surplus parts and personnel is calculated. In the case of the planned production, extra resources are generally reserved in advance to prepare any contingency. In contrast, in the present invention, when calculating a spare capacity from the surplus resources, a production capacity is calculated by tracing BOM (Bills of materials)/BOP (Bill of process) in the opposite direction of the MRP case. For this reason, the method of the present invention can be called reverse MRP.

Hereinafter, exemplary embodiments of the present invention will be explained with reference to the drawings.

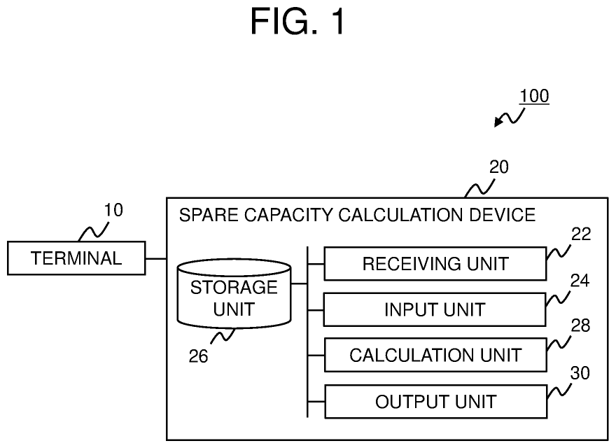

FIG. 1 is a block diagram showing a configuration example of an exemplary embodiment of a spare capacity response system according to the present invention. The spare capacity response system 100 of this exemplary embodiment includes a terminal 10 and a spare capacity calculation device 20.

The terminal 10 is a device that sends an inquiry to the spare capacity calculation device about surplus productions that can be supplied (i.e., the production capacity). The terminal may, for example, inquire about the production capacity by specifying the product and the due date. The production capacity may also be said to be a production capacity of the target product on the specified date. The terminal 10 uses a processor of a computer operating according to a program to realize the inquiry to the spare capacity calculation device 20.

The spare capacity calculation device 20 includes a receiving unit 22, an input unit 24, a storage unit 26, a calculation unit 28, and an output unit 30.

The receiving unit 22 receives an inquiry about a production capacity from other devices. Specifically, the receiving unit 22 receives an inquiry about a production capacity specified by a product. The receiving unit 22 may also receive an inquiry about a production capacity specifying a due date.

The input unit 24 accepts an input of the process capability to be made available for each unit period for each production process of the target product, and an input of the number of materials to be made available. Specifically, the input unit 24 accepts an input of the process capability to be made available for each unit period, for each production process of the target product, and an input of the number of materials to be made available for each unit period. The unit period is predetermined, for example, by a unit of a day, a week, a month, a half day, or the like. For the sake of simplicity, hereinafter the unit period is a day. However, the unit period is not limited to a day.

The process in this exemplary embodiment represents a specific operation, such as a so-called assembly process or a painting process. The process capability represents the maximum number of products that can be produced per unit period in a certain process. The process capability is the maximum number of products that can be produced at the time the production capacity is calculated, and is a number that changes from time to time according to other production plans, etc.

The number of materials to be available is the number of materials that are available at the time the production capacity is calculated among materials used in the production of the target product. The number of materials to be available is a number that changes from time to time according to other production plans, etc.

In this exemplary embodiment, the process capability and the number of materials to be made available for each unit period for each production process are specified in advance and stored in the storage unit 26 or the like, for example.

The storage unit 26 stores a bill of process and a bill of materials used in the production of the target product. Specifically, the storage unit 26 stores a bill of process that represents a process flow for each part in assembling the product, and a bill of materials that represents a list of parts (including a hierarchical structure) in assembling the product. The storage unit 26 may store a commonly known BOM/BOP, for example.

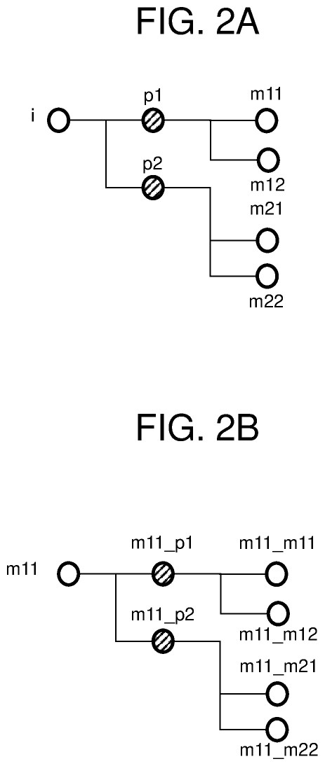

FIGS. 2A and 2B are explanatory diagrams showing examples of a bill of process and a bill of materials. The example shown in FIGS. 2A and 2B indicates, for example, that a process p1 and a process p2 are required to produce the final product i, and that materials m11 to m22 are used, respectively. Further, it indicates that processes m11_p 1 and m11_p2 are required to produce the material m11, and that materials m11_m11 to m11_m22 are used, respectively.

In this exemplary embodiment, the bill of process and the bill of materials illustrated in FIGS. 2A and 2B are assumed. However, the contents of the bill of process and the bill of materials are not limited to those illustrated in FIGS. 2A and 2B. For example, when a bill of process and a bill of materials different from those illustrated in FIGS. 2A and 2B are used, the spare capacity calculation device 20 may include a conversion unit (not shown) that converts them to this bill of process and this bill of materials. In this case, the conversion unit may convert the target bill of process and the target bill of materials to the the bill of process and the bill of materials as illustrated in FIGS. 2A and 2B.

The bill of process may also include a work period for each process (for example, more than 1 day, within 3 days, etc.).

The calculation unit 28 calculates a surplus production capacity that can be supplied (the production capacity) at the time of the inquiry based on the process capability and the number of materials to be available for each unit period for each production process. The method of calculating the production capacity is described in detail below.

First, the calculation unit 28 calculates an accumulated material number by accumulating the number of materials to be available in time series from a predetermined point in the past (hereinafter sometimes referred to as the starting point). For example, when the unit period is a day, the calculation unit 28 calculates the accumulated material number by adding the number of materials to be available for each date from the starting point along the date in order from the past.

Next, the calculation unit 28 calculates a cumulative production capacity, which is the accumulated value of the production capacity in each unit period in time series from the starting point. Here, the calculation unit 28 calculates the cumulative production capacity, which is a cumulative production capacity accumulated up to an immediately preceding unit period. Unlike the process capability, the production capacity here is the number of products that can actually be produced in consideration of materials. In other words, the production capacity corresponds to the smaller one of the number of products that can be produced based on the process capability and the number of products that can be produced from the number of materials remaining (hereinafter referred to as the available number of materials) at that time. The calculation unit 28 calculates the available number of materials by subtracting the cumulative production capacity from the accumulated material number.

Then, the calculation unit 28 calculates the cumulative production capacity by accumulating the production capacities in time series from the starting point.

The output unit 30 outputs the calculated production capacity. The output unit 30 may output the calculated result to the terminal 10.

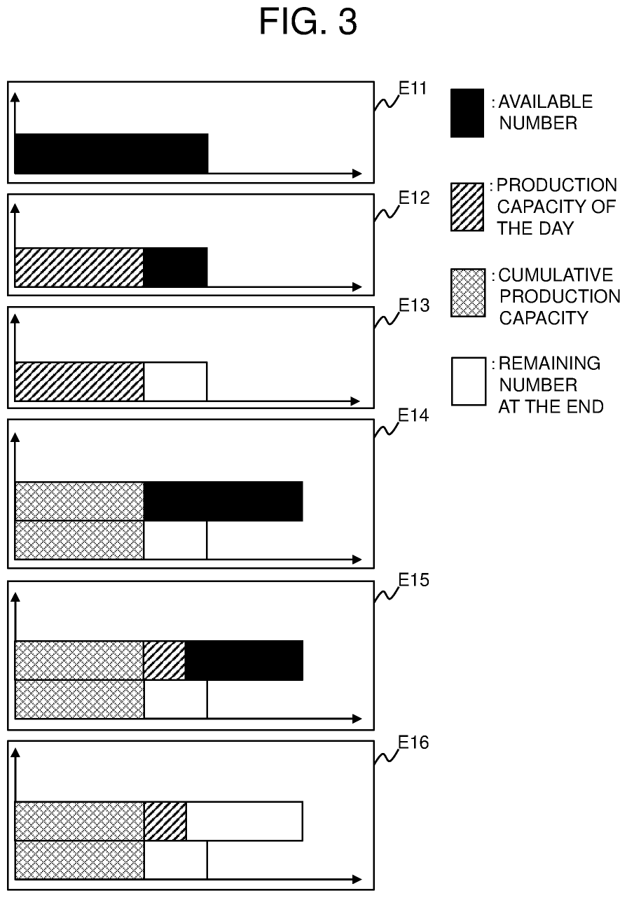

The relationship between the number of materials to be available, the production capacity, and the cumulative production capacity is described in detail below. FIG. 3 is an explanatory diagram showing an example of the process of calculating the cumulative production capacity. FIG. 3 illustrates a case in which materials are received before the process is performed and the process does not extend over unit periods (no room for schedule). The available number illustrated in FIG. 3 corresponds to the number of materials to be available (i.e., the available number of materials) described above. The horizontal axis of graphs E11 to E16 illustrated in FIG. 3 shows the cumulative number of materials or products, and the vertical axis shows time. It is also assumed that time passes in the order of graphs E11 to E16.

First, on first day, the calculation unit 28 adds the available number of materials received on the first day to the accumulated material number (graph E11). Next, the calculation unit 28 determines the production capacity of the day by taking into account the process capability. The example shown in graph E12 indicates that the process capability is lower than the available number. As a result, at the end of the first day, the production capacity is determined to be less than the available number, and the number of materials that were not used become the remaining number at the end (graph E13). The calculation unit 28 adds the production capacity for the first day to the cumulative production capacity.

Next, on the second day, the calculation unit 28 adds the number of materials received on the second day to the accumulated material number and further adds the remaining number at the end of the previous day to determine the available number for the second day (graph E14). Next, the calculation unit 28 determines the production capacity of the day by taking into account the process capability (graph E15). The example shown in graph E15 also indicates that the process capability is lower than the available number. As a result, at the end of the second day, the production capacity is determined to be less than the available number, and the number of the materials that were not used become the remaining number at the end (graph E16). The calculation unit 28 also adds the production capacity for the second day to the cumulative production capacity.

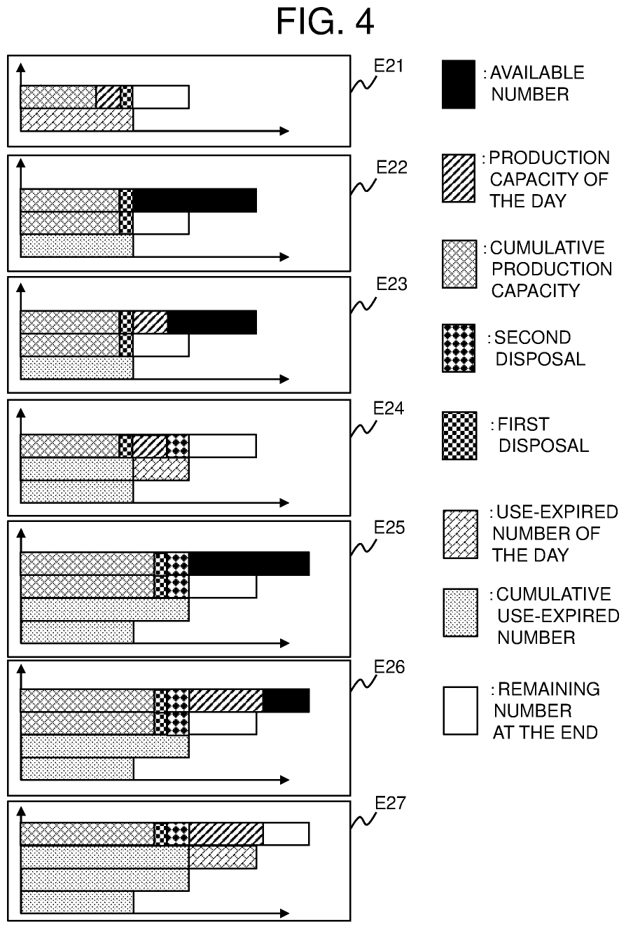

FIG. 4 is an explanatory diagram showing another example of the process of calculating a cumulative production capacity. FIG. 4 illustrates a case in which materials are received before the process is performed, the schedule does not extend over unit periods, and the materials are disposed after the end of the operation of the next day. In this exemplary embodiment, it is assumed that the materials are disposed after the usable period.

The available number illustrated in FIG. 4 also corresponds to the number of materials to be available described above, and the transition up to the second day is assumed to be the same as in graphs E11-E15 illustrated in FIG. 3. The horizontal axis of graphs E21 to E27 illustrated in FIG. 4 also shows the cumulative number of materials or products, and the vertical axis shows time. It is also assumed that time passes in the order of graphs E21 to E27.

The calculation unit 28 calculates the number of materials past their usable period as a use-expired number and subtracts the calculated use-expired number from the available number. Specifically, the calculation unit 28 subtracts the use-expired number of materials of the day from a sum of the production capacity of the day and the cumulative production capacity, to determine the number of materials to be disposed of the day. Here, at the end of the second day, the use-expired number of materials of the day is equal to the available number for the first day. Since the production capacity of that day+the cumulative production capacity<the use-expired number of the day, disposal (first disposal) occurs (graph E21). The material disposed of here will be reduced so that it is not included in the available number of the next day and thereafter.

Next, on the third day, the calculation unit 28 adds the number of materials received on the third day to the accumulated material number and also adds the remaining number at the end of the previous day to determine the available number (graph E22). Next, the calculation unit 28 determines the production capacity of the day by taking into account the process capability (graph E23). The example shown in graph E23 indicates that the process capability is lower than the available number and that the materials received on the second day were not used up. The calculation unit 28 determines the number of materials to be disposed of the day by subtracting the cumulative use-expired number and the use-expired number of the day from a sum of the production capacity of the day, the cumulative production capacity, and the cumulative disposal number. The cumulative use-expired number is the value obtained by accumulating the use-expired numbers in time series from the starting point. Here, since the production capacity of the day+the cumulative production capacity+the cumulative disposal number<the cumulative use-expired number+the use-expired number of the day, disposal (second disposal) occurs (graph E24). The calculation unit 28 adds the production capacity for the third day to the cumulative production capacity, the disposal number (the number of materials to be disposed) for the third day to the cumulative disposal number, and the use-expired number for the third day to the cumulative use-expired number, respectively.

Next, on the fourth day, the calculation unit 28 adds the number of materials received on the fourth day to the accumulated material number and also to the remaining number at the end of the previous day to determine the available number (graph E25). Next, the calculation unit 28 determines the production capacity of the day by taking into account the process capability (graph E26). In the example shown in graph E26, the process capability is lower than the available number, indicating that the materials received by the second day has been used up. Here, no disposal occurs because the production capacity of the day+the cumulative production capacity+the cumulative disposal number>the cumulative use-expired number+the use-expired number of the day (graph E27). The calculation unit 28 adds the production capacity for the fourth day to the cumulative production capacity, and the use-expired number for the fourth day to the cumulative use-expired number, respectively.

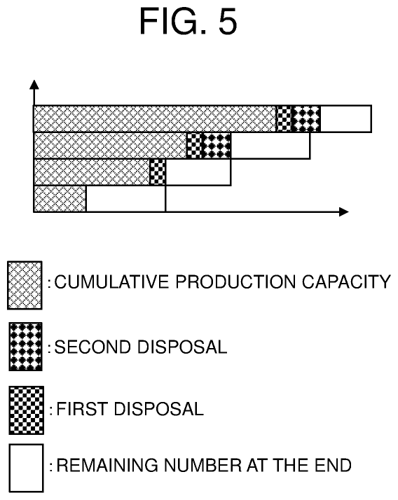

FIG. 5 is an explanatory diagram showing a result of the process illustrated in FIG. 4. As illustrated in FIG. 5, the production capacities are calculated based on the process capability and the available number, and the calculated production capacities are added cumulatively. In addition, the disposed quantity is no longer added to the available number thereafter.

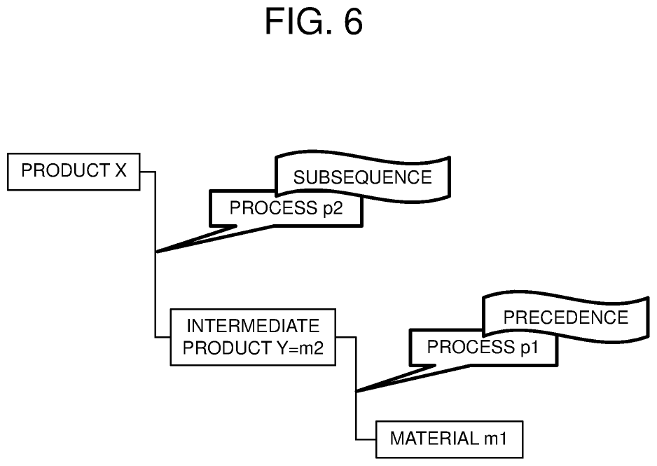

Next, the operation of the calculation unit 28 in this exemplary embodiment is explained with specific numerical examples. FIG. 6 is an explanatory diagram showing an example of a bill of process and bill of materials used in the following operation example. In the bill of process and bill of materials illustrated in FIG. 6, it is assumed that an intermediate product Y (=material m2) is produced in a process p1 using a material m1 and a product X is produced in a process p2 using a material m2. The process p1 is the process that precedes the process p2, and the process p2 is the process subsequent to the process p1.

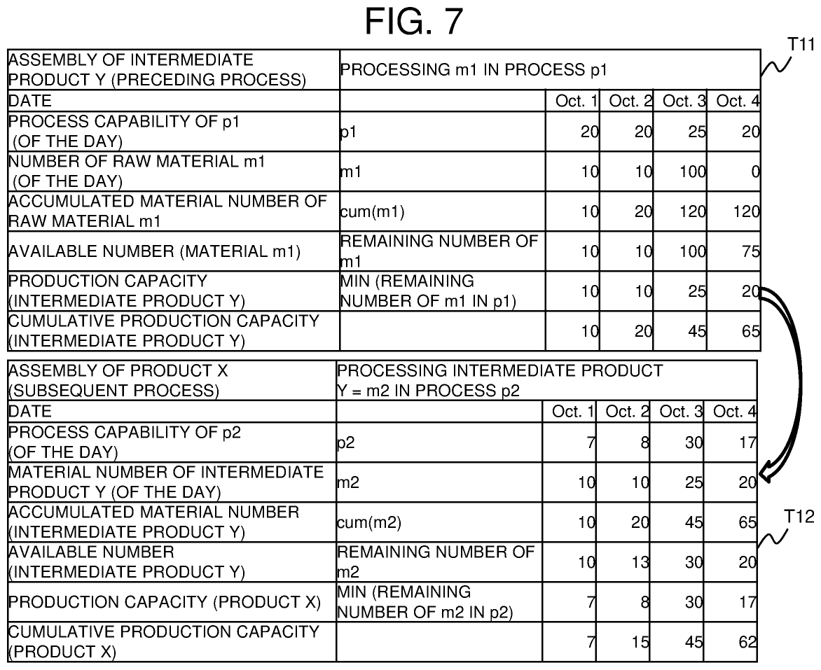

FIG. 7 is an explanatory diagram showing a first example of the operation. The first example of the operation is an example when there are no constraints between processes. The process capability (of the day) in each table indicates a process capability of intermediate products or products, and the number of raw materials (of the day) or the material number of intermediate materials (of the day) indicates the number of materials that will be available on that day. The (raw) accumulated material number indicates the material accumulation value, and the available number indicates the number of remaining materials.

In the following explanation, the case in which one material is used in the production of one intermediate product or one product is illustrated. When multiple materials are used in the production of each intermediate product or each product, the number of materials should be varied according to the number of used materials. Table T11 shows an example of a transition of the assembly of intermediate product Y Table T12 shows an example of a transition of the assembly of product X.

For example, in the preceding process of assembling intermediate product Y, assume that the process capability of intermediate product Y on October 1 is 20, and the number of materials to be available to be received on that day is 10. The accumulated material number is 10 for October 1, and the number of remaining materials is 10 (assuming that no materials have been used up to the previous day). In this case, on October 1, the production capacity is 10 because the available number is less than the process capability. As a result, the cumulative production capacity on October 1 is 10 that is the same as the production capacity for October 1.

Next, in the preceding process of assembling intermediate product Y, assume that the process capability of intermediate product Y on October 2 is 20, and the number of materials to be available to be received on that day is 10. The accumulated material number is 20, which is a sum of the number of materials for October 1 and the number of materials for October 2, and the number of remaining materials is 10, because 10 materials have been used by the previous day. In this case, on October 2, the production capacity is 10 because the available number is less than the process capability. As a result, the cumulative production capacity on October 2 is which is a sum of the production capacity of 10 on October 1 and the production capacity of on October 2.

Further, in the preceding process of assembling intermediate product Y, assume that the process capability of intermediate product Y on October 3 is 25, and the number of materials to be available to be received on that day is 100. The accumulated material number is 120, which is the accumulated number of materials from October 1 to October 3, and the number of remaining materials is 100, because 20 materials have been used by the previous day. In this case, on October 3, the production capacity is 25 because the available number is greater than the process capability. As a result, the cumulative production capacity on October 3 is 45, which is a number obtained by accumulating the production capacities from October 1 to October 3. The same is true for October 4.

On the other hand, in the subsequent process of assembling product X, assume that the process capability of product X on October 1 is 7, and the number of intermediate products Y to be produced on that day is 10 based on the above example. The accumulated material number is 10 on October 1, and the number of remaining materials is 10 (assuming that no materials have been used up to the previous day). In this case, on October 1, the production capacity is 7, because the available number is greater than the process capability. As a result, the cumulative production capacity on October 1 is 7 that is the same as the production capacity on October 1.

Next, in the subsequent process of assembling product X, assume that the process capability of product X on October 2 is 8, and the number of intermediate product Y to be produced on that day is 10 based on the above example. The accumulated material number is which is a sum of the number of materials of 10 on October 1 and the number of materials of on October 2, and the number of remaining materials is 13, because 7 materials have been used by the previous day. In this case, on October 2, the production capacity is 8 because the available number is greater than the process capability. As a result, the cumulative production capacity on October 2 is 15, which is a sum of the production capacity of 7 on October 1 and the production capacity of 8 on October 2.

Further, in the subsequent process of assembling product X, assume that the process capability of product X on October 3 is 30, and the number of intermediate products Y to be produced on that day is 25 based on the above example. The accumulated material number is which is the accumulated number of materials from October 1 to October 3, and the number of remaining materials is 30, because 15 materials were used by the previous day. In this case, on October 3, the production capacity is 30 because the available number is greater than the process capability. As a result, the cumulative production capacity on October 3 is 45, which is a number obtained by accumulating the production capacities from October 1 to October 3. The same is true for October 4.

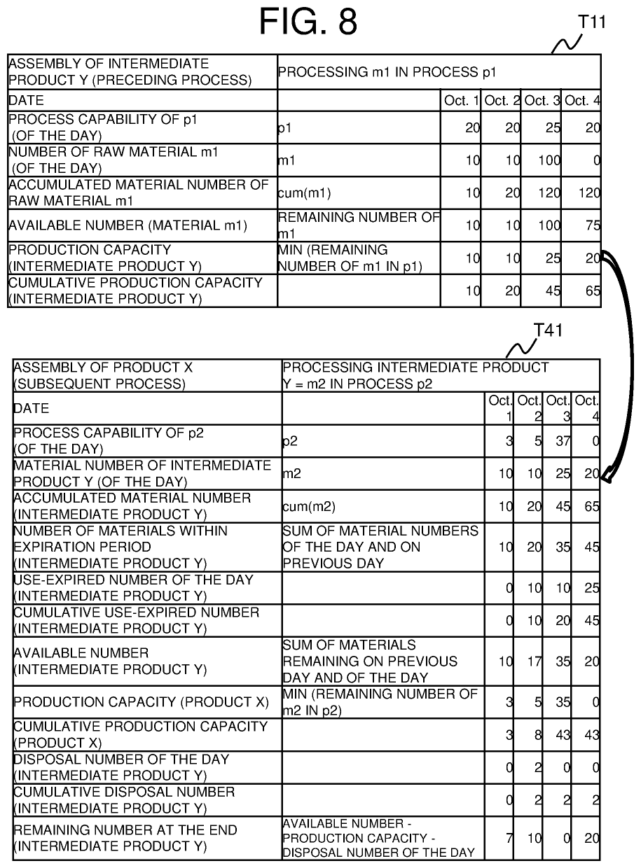

Next, a second example of operation is described. FIG. 8 illustrates the second operation example. The second example of operation is when a part (intermediate product Y) is held for one day.

The manufacturing process for intermediate product Y is assumed to be the same as in the first operational example illustrated in FIG. 7. Table T41 shows an example of a transition of the assembly of product X in this specific example. In Table T41, the number of materials within the expiration period is a sum of materials (intermediate product Y) for the available period (more specifically, the day of use and the previous day). The use-expired number of the day represents the number of materials to be available received on the previous day, and the cumulative use-expired number is a cumulative value of the use-expired numbers from October 1 to the current day.

Further, the available number indicates a sum of the number of remaining materials at the end of the previous day and the number of materials to be available received on the current day. The disposal number of the day is a value calculated by the cumulative use—expired number—the cumulative production capacity—the cumulative disposal number on the previous day. When the calculated disposal number of the day is less than or equal to 0, the disposal number of the day is 0 because no disposal occurs. The remaining number at the end is a value calculated by the available number—the production capacity—the disposal number of the day.

In the subsequent process of assembling product X, assume that the process capability of product X on October 1 is 3, and the number of produced intermediate product Y of the day is 10 based on the above example. The accumulated material number is 10 on October 1, the available number is 10, and the number of materials within the expiration period is also 10. Since there is no intermediate product Y that has already been created, the use-expired number of the day (disposal number of the day) and the cumulative use-expired number (cumulative disposal number) are 0. In this case, on October 1, the production capacity is 3 because the available number is greater than the process capability. As a result, the cumulative production capacity on October 1 is 3 that is the same as the production capacity for October 1. The remaining number at the end of October 1 is 7, which is obtained by subtracting the production capacity of 3 from the available number of 10.

Next, assume that the process capability of product X on October 2 is 5, and the number of intermediate products Y produced on that day is 10 based on the above example. The accumulated material number is 20, which is a sum of the number of materials of 10 on October 1 and the number of materials of 10 on October 2, 10, and the number of materials within the expiration period is also 20. The available number is 17, which is a sum of the number of remaining materials of 7 at the end of the previous day and the number of materials of 10 of the day. The use-expired number of the day is 10, which is the number of materials received on October 1, and the cumulative use-expired number is also 10.

In this case, on October 2, the production capacity is 5 because the available number is greater than the process capability. As a result, the cumulative production capacity on October 2 is 8, which is a sum of the production capacity of 3 on October 1 and the production capacity of 5 on October 2. Here, since two materials were not used up on October 1 (i.e., the cumulative use—expired number of 10—the cumulative production capacity of 8—the cumulative disposal number on the previous day of 0=2), the disposal number of the day is 2. As a result, the cumulative disposal number is also 2. The remaining number at the end of October 2 is 10, which is obtained by subtracting the production capacity of 5 and the disposal number of the day of 2 from the available number of 17.

Next, assume that the process capability of product X on October 3 is 37, and the number of produced intermediate products Y of the day is 25 based on the above example. The accumulated material number is 45, which is the accumulated material number from October 1 to October 3, and the number of materials within the expiration period is 35. The available number of materials is 35, which is a sum of the number of remaining materials of 10 at the end of the previous day and the number of materials of 25 of the day. The use-expired number of the day is 10, which is the number of materials to be received on October 2, and the cumulative use-expired number is 20.

In this case, on October 3, the production capacity is 35 because the available number is less than the process capability. As a result, the cumulative production capacity on October 3 is 43, which is a number obtained by accumulating the production capacities from October 1 to October 3. Here, since all the materials have been used up (i.e., the cumulative use-expired number of 20—the accumulated production capacity of 43—the cumulative disposal number on the previous day of 10<0), the disposal number of the day is 0. As a result, the cumulative disposal number remains 2. The remaining number at the end of October 3 is 0, which is obtained by subtracting the production capacity of 35 and the disposal number of the day of 0 from the available number of 35. The same calculation is true for October 4.

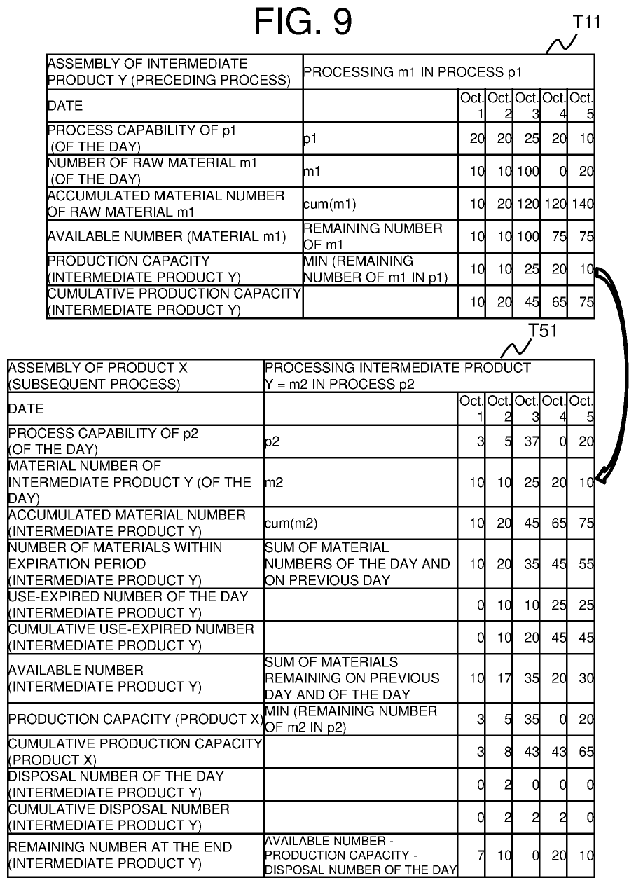

Next, a third example of operation is described. FIG. 9 is an explanatory diagram showing a third example. The third operation example is a case where a part (intermediate product Y) is held for two days. The manufacturing process of intermediate product Y is assumed to be the same as in the first operational example illustrated in FIG. 7. Table T51 shows an example of a transition of the assembly of product X in this specific example. Compared to the second specific example, there is a two-day grace period before disposal. Therefore, since the disposal number of the day is 0 on October 2 in Table T51, no disposal occurs anymore based on the production on October 3.

As described above, the operation of the calculation unit 28 in this exemplary embodiment is explained based on the first to third operation examples. In all of the first to third operation examples, the case in which there is only one production process for intermediate product Y is illustrated. However, as illustrated in FIG. 2, there may be multiple production processes (for example, process p1 and process p2) for a product (for example, product i). The multiple processes may take place within one unit period or extend over multiple unit periods.

The receiving unit 22, the input unit 24, the calculation unit 28, and the output unit 30 are realized by a computer processor (for example, CPU (Central Processing Unit)) that operates according to a program (spare capacity calculation program).

For example, the program may be stored in the storage unit 26, and the processor may read the program and operate as the receiving unit 22, the input unit 24, the calculation unit 28, and the output unit 30 according to the program. The functions of the spare capacity calculation device 20 may be provided in a SaaS (Software as a Service) format.

Each of the receiving unit 22, the input unit 24, the calculation unit 28, and the output unit 30 may be realized by dedicated hardware. Some or all of the components of each device may be realized by general-purpose or dedicated circuit (circuitry), processors, etc., or a combination thereof. They may be configured by a single chip or by multiple chips connected through a bus. Some or all of the components of each device may be realized by a combination of the above-mentioned circuit, etc. and a program.

When some or all of the components of the spare capacity calculation device 20 are realized by multiple information processing devices, circuits, etc., the multiple information processing devices, the circuit, etc. may be arranged in a centralized or distributed manner. For example, the information processing devices, circuits, etc., may be realized as a client-server system, a cloud computing system, or the like, each of which is connected through a communication network.

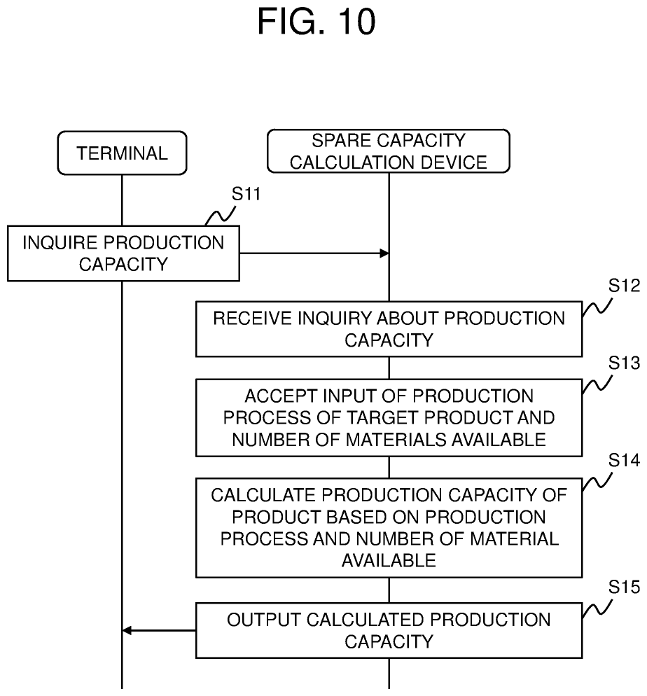

Next, the operation of the spare capacity response system of this exemplary embodiment will be explained. FIG. 10 is a flowchart showing an example of the operation of the spare capacity response system 100. The terminal 10 inquires the production capacity to the spare capacity calculation device 20 (step S11), and the receiving unit 22 of the spare capacity calculation device 20 receives the inquiry about the production capacity from the terminal 10 (step S12).

The input unit 24 accepts an input of the process capability for each production process of the target product and the number of materials available, for each unit period (step S13). The calculation unit 28 calculates the production capacity of the product that can be supplied at the time of the inquiry, based on the production process to be available and the number of materials to be available (step S14). The output unit 15 outputs the calculated production capacity to the terminal 10 (step S15).

In FIG. 10, the method of calculating the production capacity in response to an inquiry from terminal 10 is shown as an example. However, the spare capacity calculation unit 20 may calculate the production capacity in advance, prior to receiving an inquiry from the terminal 10. Such a configuration makes it possible to disclose the production capacity in advance.

As described above, in this exemplary embodiment, the input unit 24 accepts inputs of the process capability to be made available for each unit period for each production process of the target product, and the number of materials to be made available for each unit period. Then, the calculation unit 28 calculates the accumulated material number by accumulating the number of materials for each unit period from the starting point, and subtracts the cumulative production capacity up to the immediately preceding unit period from the accumulated material number to calculate the available number of materials. Further, the calculation unit 28 determines the smaller one of the number of products that can be produced, which is calculated based on the process capability, and the number of products that can be produced, which is calculated based on the available number of materials, as the production capacity, and calculates the cumulative production capacity for each unit period by accumulating the product capabilities in time series from the starting point. Therefore, the spare capacity can be calculated taking into consideration processes and materials required for production.

In addition, it is also possible to establish an OEM (Original Equipment Manufacturing) system by using the spare capacity calculation device of this exemplary embodiment to calculate the productive capacity corresponding to the manufacturer and allowing the supplier to respond.

Next, a modification of the spare capacity response system of this exemplary embodiment will be explained. In the above exemplary embodiment, the case in which the number of materials to be available is stored in the storage unit 26 is illustrated. In this specific example, a case is explained in which a spare capacity for intermediate products of a product is calculated and the calculated spare capacity is treated as the number of parts of the final product.

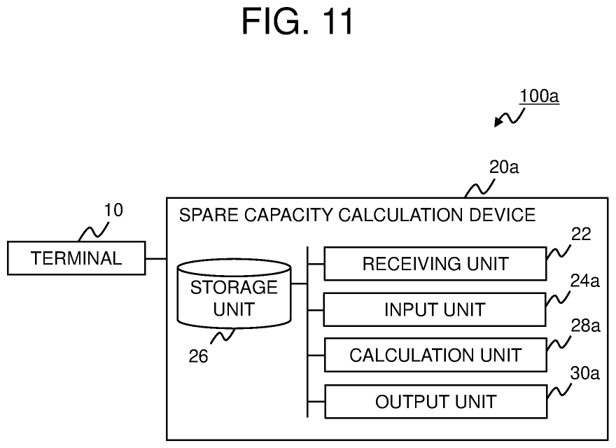

FIG. 11 is a block diagram showing a modification of the spare capacity response system of this exemplary embodiment. The spare capacity response system 100a in this modification includes a terminal 10 and a spare capacity calculation device 20a. The entity of terminal 10 is the same as in the above exemplary embodiment.

The spare capacity calculation device 20a includes a receiving unit 22, an input unit 24a, a storage unit 26, a calculation unit 28a, and an output unit 30a. The entities of the receiving unit 22 and the storage unit 26 are the same as in the above exemplary embodiment.

As in the above exemplary embodiment, the input unit 24a accepts inputs of the process capability for each production process of the target product and the number of materials to be made available, for each unit period. In addition, in this exemplary embodiment, the input unit 24a determines whether or not it is possible to calculate the spare capacity of materials (hereinafter referred to as “intermediate parts”) used in the production of the target product. In case that it is possible to calculate the spare capacity of intermediate parts, the input unit 24a accepts inputs of the process capability for each production process of the intermediate part and the number of materials to be made available, for each unit period.

As in the above exemplary embodiment, the calculation unit 28a calculates the production capacity of products and intermediate parts that can be supplied at the time of inquiry based on the process capability to be available and the number of materials to be available. The output unit 30a then outputs the calculated production capacity of products or intermediate parts. Specifically, the calculation unit 28a first calculates the production capacity of intermediate parts. Then, the output unit 30a outputs to the input unit 24a the calculated production capacity as the number of materials of the intermediate parts m available for the production of the product. The calculation unit 28a calculates the production capacity of the product based on the number of materials of intermediate parts accepted by the input unit 24a. When there are multiple intermediate parts, the process described above should be repeated.

The receiving unit 22, the input unit 24a, the calculation unit 28a, and the output unit 30a are also realized by a computer processor that operates according to a program (spare capacity calculation program).

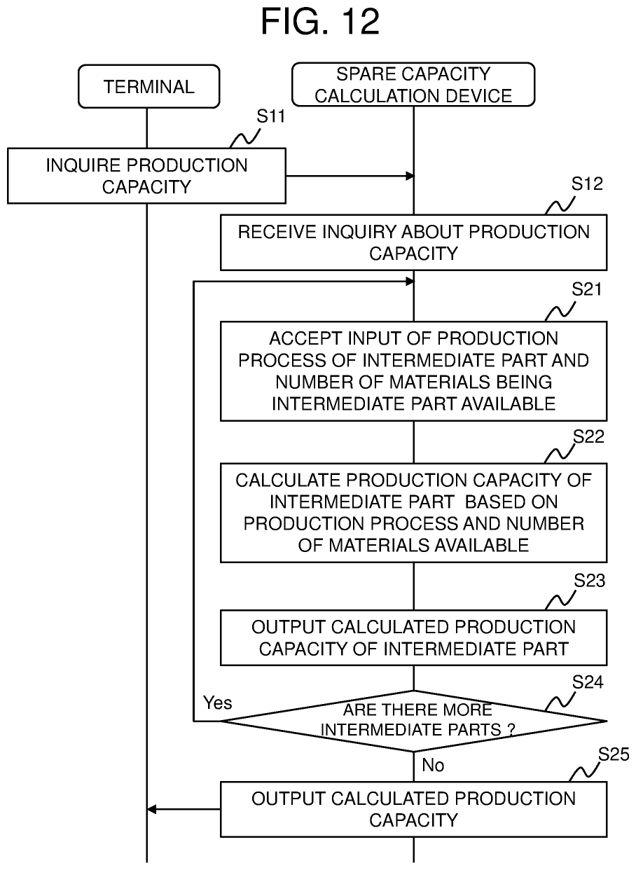

Next, the operation of the spare capacity response system of this modification will be explained. FIG. 12 is a flowchart showing an example operation of the spare capacity response system 100a of this modification. The operation example shown in FIG. 12 assumes that the spare capacity calculation device 20a is capable of calculating the spare capacity of intermediate parts of products. The process up to receiving an inquiry from the terminal 10 about the production capacity is the same as the process from step S11 to step S12 illustrated in FIG. 10.

The input unit 24a accepts inputs of the process capability to be made available for each unit period for each production process of the intermediate part and the number of available materials being the intermediate parts (step S21). Then, the calculation unit 28a calculates the production capacity of the intermediate part based on the production process and the number of materials to be available (step S22). The output unit 30a then outputs the calculated production capacity to the input unit 24a as the number of materials of the intermediate part available for production (step S23).

The input unit 24a determines whether or not there are more intermediate parts that use the input intermediate parts as materials (step S24). When there are more intermediate parts to be used as materials (Yes in step S24), the process from step S21 onward is repeated. On the other hand, when there are no intermediate parts to be used as materials (No in step S24), the production capacity of the inquired product is calculated and output to the terminal 10 (step S25).

As described above, in this modification, the input unit 24a accepts inputs of the process capability to be made available for each unit period for each production process of the intermediate part, and the number of materials of the intermediate part available for each unit period. Then, the calculation unit 28a calculates the cumulative production capacity of intermediate parts for each unit period and calculates the cumulative production capacity of the product using the calculated cumulative production capacity as the number of materials to be available for the production of the product. Therefore, in addition to the effects of the above exemplary embodiment, the spare capacity (production capacity) can be calculated for a product that requires multiple processes using different materials.

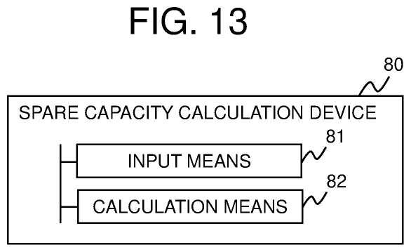

Next, an overview of the invention will be explained. FIG. 13 is a block diagram showing an overview of the spare capacity calculation device according to the present invention. The spare capacity calculation device 80 (for example, the spare capacity calculation device 20) according to the present invention includes input means 81 (for example, the input unit 24) which accepts an input of a process capability to be made available for each unit period (for example, a day, a week, a month, a half day, or the like) for each production process of a target product, and an input of the number of materials to be made available (for example, the number of remaining materials considering other production) for each unit period, and calculation means 82 (for example, the calculation unit 28) which calculates an accumulated material number (for example, material accumulation) by accumulating the number of materials in time series from a predetermined point in the past (for example, the starting point), and calculates the available number of materials by subtracting a cumulative production capacity accumulated up to an immediately preceding unit period (for example, the previous day) among cumulative production capacities, each of which is a value obtained by accumulating a production capacity in each unit period in time series from the accumulated material number.

The calculation means 82 determines the smaller one of the number of products that can be produced, which is calculated based on the process capability, and the number of products that can be produced, which is calculated based on the available number of materials, as the production capacity, and accumulates the production capacities in time series from a predetermined point in the past (for example, the starting point) to calculate the cumulative production capacity for each unit period.

Such a configuration makes it possible to calculate the spare capacity taking into consideration the processes and materials required for production.

The calculation means 82 may also calculate a disposal number based on the number of materials past their usable period, and calculates the number of remaining materials based on the calculated disposal number. Such a configuration makes it possible to calculate the spare capacity more appropriately, because the disposed quantity can be excluded from the remaining number of materials to be available.

Specifically, the calculation means 82 may calculate the available number which is the number of materials to be made available for a target unit period by adding the number of remaining materials (for example, remaining number at the end) immediately before (for example, the previous day) each unit period and the number of materials to be made available for the target unit period, and determines the smaller one of the number of products that can be produced, which is calculated based on the process capability and the number of products that can be produced, which is calculated based on the calculated available number, as the production capacity.

Such a configuration makes it possible to determine the production capacity for the unit period based on the number of remaining materials remaining immediately before and the number of materials be available for the target unit period, even when disposal may occur during production.

More specifically, the calculation means 82 may calculate a cumulative use-expired number obtained by accumulating use-expired numbers for each unit period which are the number of materials past their usable period in the target unit period, calculates a cumulative disposal number obtained by accumulating the disposal number actually disposed (for example, the disposal number of the day) for each unit period, and regards the greater value of 0 and a value obtained by subtracting the cumulative production capacity and the cumulative disposal number up to the immediately preceding unit period from the use-expired number as the disposal number for the target unit period.

The calculation method 82 may also calculate the number of remaining materials in each unit period by subtracting the production capacity and the disposal number from the available number.

The input means 81 (for example, the input unit 24a) may also accept an input of the process capability for each unit period for each production process of an intermediate part (for example, intermediate product Y) which is a material used in the production of the target product, and an input of the number of materials of the intermediate part available for each unit period. The calculation means 82 (for example, the calculation unit 28a) may then calculate a production capacity of the intermediate part for each unit period, and calculates the production capacity of the product using the calculated production capacity as the number of materials available for the production of the product.

Such a configuration makes it possible to calculate the spare capacity of the product taking into consideration the spare capacity of intermediate products.

The calculation means 82 may also calculate the production capacity of the target product for each unit period depending on a usable period (for example, after 3 day, etc.) of the intermediate part produced. Such a configuration makes it possible to calculate the spare capacity appropriately in the production of the product that cannot proceed to subsequent processes until a predetermined date has elapsed after the production of intermediate parts, for example.

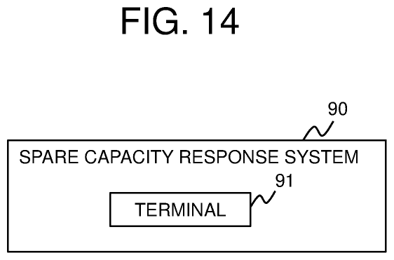

FIG. 14 is a block diagram showing an overview of the spare capacity response system according to the present invention. The spare capacity response system 90 (for example, the spare capacity response system 100) according to the present invention includes a terminal 91 (for example, the terminal 10) which sends an inquiry about a production capacity to a spare capacity calculation device (for example, the spare capacity calculation device 20) which calculates the production capacity of a target product.

The configuration of the spare capacity calculation device is the same as that of the spare capacity calculation device 80 illustrated in FIG. 13.

Such a configuration also makes it possible to calculate the spare capacity taking into consideration the processes and materials required for production.

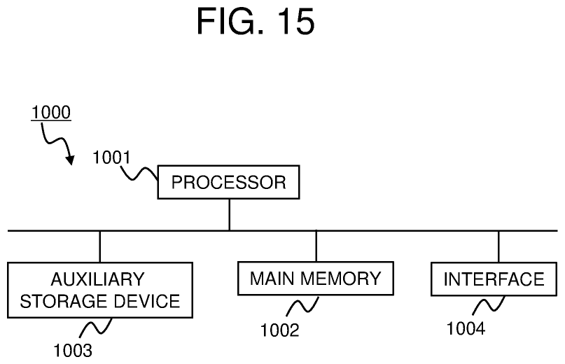

FIG. 15 is a summarized block diagram showing a configuration of a computer for at least one exemplary embodiment. The computer 1000 comprises a processor 1001, a main memory 1002, an auxiliary memory 1003, and an interface 1004.

The spare capacity calculation device 80 described above is implemented in a computer 1000. The operation of each of the above described processing parts is stored in the auxiliary storage 1003 in the form of a program (spare capacity calculation program). The processor 1001 reads the program from the auxiliary storage 1003, develops it to the main memory 1002, and executes the above described processing according to the program.

In at least one exemplary embodiment, the auxiliary memory 1003 is an example of a non-transitory tangible medium. Other examples of a non-transitory tangible medium include a magnetic disk, an optical magnetic disk, a CD-ROM (Compact Disc Read-only memory), a DVD-ROM (Read only memory), semiconductor memory, and the like. When the program is delivered to the computer 1000 through a communication line, the computer 1000 receiving the delivery may extract the program into the main memory 1002 and execute the above processing.

The program may be a program for realizing a part of the above described functions. Further, the program may be a so-called difference file (difference program) that realizes the aforementioned functions in combination with other programs already stored in the auxiliary memory 1003.

A part of or all of the above exemplary embodiments may also be described as, but not limited to, the following supplementary notes.

(Supplementary note 1) A spare capacity calculation device comprising:
input means for accepting an input of a process capability to be made available for each unit period for each production process of a target product, and an input of the number of materials to be made available for each unit period; and
calculation means for calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number,
wherein the calculation means determines the smaller one of the number of products that can be produced, which is calculated based on the process capability, and the number of products that can be produced, which is calculated based on the available number of materials, as the production capacity, and accumulates the production capacities in time series from a predetermined point in the past to calculate the cumulative production capacity for each unit period.

(Supplementary note 2) The spare capacity calculation device according to Supplementary note 1, wherein
the calculation means calculates a disposal number based on the number of materials past their usable period, and calculates the number of remaining materials based on the calculated disposal number.

(Supplementary note 3) The spare capacity calculation device according to Supplementary note 2, wherein
the calculation means calculates the available number which is the number of materials to be made available for a target unit period by adding the number of remaining materials immediately before each unit period and the number of materials to be made available for the target unit period, and determines the smaller one of the number of products that can be produced, which is calculated based on the process capability and the number of products that can be produced, which is calculated based on the calculated available number, as the production capacity.

(Supplementary note 4) The spare capacity calculation device according to Supplementary note 3, wherein
the calculation means calculates a cumulative use-expired number obtained by accumulating use-expired numbers for each unit period which are the number of materials past their usable period in the target unit period, calculates a cumulative disposal number obtained by accumulating the disposal number actually disposed for each unit period, and regards the greater value of 0 and a value obtained by subtracting the cumulative production capacity and the cumulative disposal number up to the immediately preceding unit period from the use-expired number as the disposal number for the target unit period.

(Supplementary note 5) The spare capacity calculation device according to Supplementary note 3 or 4, wherein
the calculation means calculates the number of remaining materials in each unit period by subtracting the production capacity and the disposal number from the available number.

(Supplementary note 6) The spare capacity calculation device according to any one of Supplementary notes 1 to 5, wherein
the input means accepts an input of the process capability for each unit period for each production process of an intermediate part which is a material used in the production of the target product, and an input of the number of materials of the intermediate part available for each unit period, and
the calculation means calculates a production capacity of the intermediate part for each unit period, and calculates the production capacity of the product by using the calculated production capacity as the number of materials available for the production of the product.

(Supplementary note 7) The spare capacity calculation device according to Supplementary note 6, wherein
the calculation means calculates the production capacity of the target product for each unit period depending on a usable period of the intermediate part produced.

(Supplementary note 8) A spare capacity response system comprising a terminal which sends an inquiry about a production capacity to a spare capacity calculation device which calculates the spare capacity of a target product and responds, wherein the spare capacity calculation device includes:
input means for accepting an input of a process capability to be made available for each unit period for each production process of the target product, and an input of the number of materials to be made available for each unit period; and
calculation means for calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number, and
wherein the calculation means determines the smaller one of the number of products that can be produced, which is calculated based on the process capability, and the number of products that can be produced, which is calculated based on the available number of materials, as the production capacity, and accumulates the production capacities in time series from a predetermined point in the past to calculate the cumulative production capacity for each unit period.

(Supplementary note 9) A spare capacity calculation method comprising:
accepting an input of a process capability to be made available for each unit period for each production process of a target product, and an input of the number of materials to be made available for each unit period;
calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number; and
determining the smaller one of the number of products that can be produced, which is calculated based on the process capability, and the number of products that can be produced, which is calculated based on the available number of materials, as the production capacity, and accumulating the production capacities in time series from a predetermined point in the past to calculate the cumulative production capacity for each unit period.

(Supplementary note 10) The spare capacity calculation method according to Supplementary note 9, further comprising
calculating a disposal number based on the number of materials past their usable period, and calculating the number of remaining materials based on the calculated disposal number.

(Supplementary note 11) A spare capacity response method, wherein
a terminal sends an inquiry about a production capacity for a target product to a spare capacity calculation device which calculates the spare capacity and responds, and wherein
the spare capacity calculation device
accepts an input of a process capability to be made available for each unit period for each production process of a target product, and an input of the number of materials to be made available for each unit period;
calculates an accumulated material number by accumulating the number of materials in time series from a predetermined point in the past, and calculates the available number of materials by subtracting a cumulative production capacity accumulated up to an immediately preceding unit period among cumulative production capacities, each of which is a value obtained by accumulating the production capacity in each unit period in time series from the accumulated material number; and
determines the smaller one of the number of products that can be produced, which is calculated based on the process capability, and the number of products that can be produced, which is calculated based on the available number of materials, as the production capacity, and accumulates the production capacities in time series from a predetermined point in the past to calculate the cumulative production capacity for each unit period.

(Supplementary note 12) A program recording medium storing a spare capacity calculation program, wherein
the spare capacity calculation program causes a computer to execute:
an input process of accepting an input of a process capability to be made available for each unit period for each production process of a target product, and an input of the number of materials to be made available for each unit period; and
a calculating process of calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number, and
wherein in the calculating process, the spare capacity calculation program causes a computer to execute determining the smaller one of the number of products that can be produced, which is calculated based on the process capability, and the number of products that can be produced, which is calculated based on the available number of materials, as the production capacity, and accumulating the production capacities in time series from a predetermined point in the past to calculate the cumulative production capacity for each unit period.

(Supplementary note 13) The program recording medium according to Supplementary note 12, wherein in the calculating process, the spare capacity calculation program causes the computer to execute calculating a disposal number based on the number of materials past their usable period, and calculating the number of remaining materials based on the calculated disposal number.

(Supplementary note 14) A spare capacity calculation program causing a computer to execute:
an input process of accepting an input of a process capability to be made available for each unit period for each production process of a target product, and an input of the number of materials to be made available for each unit period; and
a calculating process of calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number, and
wherein in the calculating process, the spare capacity calculation program causes a computer to execute determining the smaller one of the number of products that can be produced, which is calculated based on the process capability, and the number of products that can be produced, which is calculated based on the available number of materials, as the production capacity, and accumulating the production capacities in time series from a predetermined point in the past to calculate the cumulative production capacity for each unit period.

(Supplementary note 15) The spare capacity calculation program according to Supplementary note 14, causing, in the calculating process, the computer to execute calculating a disposal number based on the number of materials past their usable period, and calculating the number of remaining materials based on the calculated disposal number.

Although the invention of the present application has been described above with reference to exemplary embodiments, the present invention is not limited to the above exemplary embodiments. Various changes can be made to the configuration and details of the present invention that can be understood by those skilled in the art within the scope of the present invention.

### REFERENCE SIGNS LIST

10 Terminal
20 Spare capacity calculation device
22 Receiving unit
24 Input unit
26 Storage unit
28 Calculation unit
30 Output unit
100 Spare capacity response system

What is claimed is:

1. A spare capacity calculation device comprising:
a memory storing instructions; and
one or more processors configured to execute the instructions to:
accept an input of a process capability to be made available for each unit period for each production process of a target product, and an input of the number of materials to be made available for each unit period;
calculate an accumulated material number by accumulating the number of materials in time series from a predetermined point in the past, and calculate the available number of materials by subtracting a cumulative production capacity accumulated up to an immediately preceding unit period among cumulative production capacities, each of which is a value obtained by accumulating a production capacity in each unit period in time series from the accumulated material number; and
determine the smaller one of the number of products that can be produced, which is calculated based on the process capability, and the number of products that can be produced, which is calculated based on the available number of materials, as the production capacity, and accumulates accumulate the production capacities in time series from a predetermined point in the past to calculate the cumulative production capacity for each unit period.

2. The spare capacity calculation device according to claim 1, wherein the processor is configured to execute the instructions to
calculate a disposal number based on the number of materials past their usable period, and calculate the number of remaining materials based on the calculated disposal number.

3. The spare capacity calculation device according to claim 2, wherein the processor is configured to execute the instructions to
calculate the available number which is the number of materials to be made available for a target unit period by adding the number of remaining materials immediately before each unit period and the number of materials to be made available for the target unit period, and determine the smaller one of the number of products that can be produced, which is calculated based on the process capability and the number of products that can be produced, which is calculated based on the calculated available number, as the production capacity.

4. The spare capacity calculation device according to claim 3, wherein the processor is configured to execute the instructions to
calculate a cumulative use-expired number obtained by accumulating use-expired numbers for each unit period which are the number of materials past their usable period in the target unit period, calculate a cumulative disposal number obtained by accumulating the disposal number actually disposed for each unit period, and regard the greater value of 0 and a value obtained by subtracting the cumulative production capacity and the cumulative disposal number up to the immediately preceding unit period from the use-expired number as the disposal number for the target unit period.

5. The spare capacity calculation device according to claim 3, wherein the processor is configured to execute the instructions to
calculate the number of remaining materials in each unit period by subtracting the production capacity and the disposal number from the available number.

6. The spare capacity calculation device according to claim 1, wherein the processor is configured to execute the instructions to:
accept an input of the process capability for each unit period for each production process of an intermediate part which is a material used in the production of the target product, and an input of the number of materials of the intermediate part available for each unit period; and
calculate a production capacity of the intermediate part for each unit period, and calculate the production capacity of the product by using the calculated production capacity as the number of materials available for the production of the product.

7. The spare capacity calculation device according to claim 6, wherein the processor is configured to execute the instructions to:
calculate the production capacity of the target product for each unit period depending on a usable period of the intermediate part produced.

8. A spare capacity response system comprising a terminal which sends an inquiry about a production capacity to a spare capacity calculation device which calculates the spare capacity of a target product and responds, wherein the spare capacity calculation device includes:
input means for accepting an input of a process capability to be made available for each unit period for each production process of the target product, and an input of the number of materials to be made available for each unit period; and
calculation means for calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number, and
wherein the calculation means determines the smaller one of the number of products that can be produced, which is calculated based on the process capability, and the number of products that can be produced, which is calculated based on the available number of materials, as the production capacity, and accumulates the production capacities in time series from a predetermined point in the past to calculate the cumulative production capacity for each unit period.

9. A spare capacity calculation method comprising:
accepting an input of a process capability to be made available for each unit period for each production process of a target product, and an input of the number of materials to be made available for each unit period;
calculating an accumulated material number by accumulating the number of materials in time series from a predetermined point in the past, and calculating the available number of materials by subtracting a cumulative production capacity accumulated up to an immediately preceding unit period among cumulative production capacities, each of which is a value obtained by accumulating a production capacity in each unit period in time series from the accumulated material number; and
determining the smaller one of the number of products that can be produced, which is calculated based on the process capability, and the number of products that can be produced, which is calculated based on the available number of materials, as the production capacity, and accumulating the production capacities in time series from a predetermined point in the past to calculate the cumulative production capacity for each unit period.

10. The spare capacity calculation method according to claim 9, further comprising
calculating a disposal number based on the number of materials past their usable period, and calculating the number of remaining materials based on the calculated disposal number.

11. (canceled)

12. (canceled)

13. (canceled)
